(19) United States
(12) Patent Application Publication
(10) Pub. No.: US 2024/0307983 A1
(43) Pub. Date: Sep. 19, 2024

(54) GUIDE DEVICE ON A MACHINE INLET OR MACHINE OUTLET, AND PROCESSING MACHINE

(71) Applicant: HOMAG GmbH, Schopfloch (DE)

(72) Inventors: Michael THUMM, Neustetten (DE); Christoph KIRN, Baiersbronn (DE)

(21) Appl. No.: 18/574,006

(22) PCT Filed: Jun. 23, 2022
(86) PCT No.: PCT/EP2022/067158

§ 371 Date: Dec. 23, 2023

(30) Foreign Application Priority Data
Jun. 24, 2021 (DE) 10 2021 116 333.1

(51) Int. Cl. B23D 47/04

(52) U.S. Cl. CPC B23D 47/042

(57) ABSTRACT

A guide device is provided for guiding a workpiece into or out of a processing machine. The processing machine can have a conveying means for conveying the workpiece in a feed direction (D). Further, the processing machine can have a support surface with air outlets that are adapted to create an air cushion between the support surface and the workpiece using exiting air. The support surface can be arranged at a machine infeed or a machine outfeed of the processing machine and have an extension portion, which can be arranged adjacent to a conveying means end portion of the conveying means along the feed direction (D).

### TECHNICAL FIELD

The present invention relates to a guide device which can be used to guide a workpiece, which preferably consists at least partly of wood, wood materials, metal materials or plastic, into and/or out of a processing machine. The invention also relates to a processing machine with such a guide device.

### PRIOR ART

In the field of processing workpieces, in particular workpieces made of wood or wood-like materials, in a processing machine, the use of devices is known to feed the workpieces into the processing machine or to guide the workpieces out of the processing machine. Such devices can accordingly be referred to as guide devices.

One area of application for such guide devices is, in particular, processing machines that have a conveying means for conveying the workpiece in a feed direction. In such processing machines, the guide device is arranged, for example, at a machine infeed of the processing machine. Thus, for example, guide devices are known that have a large number of conveyor rollers arranged in parallel with each other. An operator or an automated feed system or robot can feed the workpiece to the processing machine by means of the guide device at a machine infeed by pushing the workpiece over the conveyor rollers. The rolling resistance that occurs is significantly lower than the sliding resistance encountered when pushing the workpiece over a table surface or similar. The workpiece is then taken over by the conveying means of the processing machine and processed in the processing machine.

A guide device is also known, particularly in connection with woodworking machines with a conveying means, which comprises a support surface with air outlets distributed over it. Air exiting through the air outlets forms an air cushion between the support surface and the workpiece so that the workpiece can be moved smoothly over the support surface and transferred to the conveying means of the processing machine at the machine infeed. Such a guide device is also known as an air cushion table. Compared to the guide device with conveyor rollers, an air cushion table has the advantage that the workpiece is placed in a floating state, which can further minimize the friction generated by a horizontal movement of the workpiece. The low friction allows the workpiece to be moved smoothly without great physical effort.

In some known air cushion tables, the air outlets do not have a constant cross-section or they have a varying cross-section along a direction perpendicular to the support surface (see e.g., EP 2 251 127 A1), or they have a nozzle shape. Air cushion tables are also known in which the air outlets have a nozzle shape with exposed balls on the nozzles. The balls are spring-return mounted so that they only release the air outlet when the balls are pressed down by an external force, such as the weight of the workpiece.

For example, a free-standing air cushion table is known which stands in front of the machine infeed of a woodworking machine. Here, though, additional elements are also provided, such as infeed rollers or similar next to or in front of the conveying means of the processing machine to support the workpiece while it is transferred from the air cushion table to the processing machine. However, these additional elements, in particular infeed rollers, lead to the problem that the workpieces catch on the elements at the machine infeed upon transverse displacement, that is to say, displacement in a direction transverse to the feed direction, and the workpiece surface may be damaged as a result.

### DESCRIPTION OF THE INVENTION

Against the background of the known prior art, the invention is therefore based on the problem of providing a guide device for guiding a workpiece, which preferably consists at least partly of wood, wood materials, metal materials or plastic, into and/or out of a processing machine, which has a conveying means for conveying the workpiece in a feed direction, as well as a processing machine with such a guide device, in order to facilitate the feeding or insertion of workpieces into the processing machine and/or the removal of workpieces from the processing machine.

These problems are solved by the guide device according to claim 1 and the processing machine according to claim 12. Advantageous further developments of the invention are described in the respective dependent claims.

The guide device according to the invention for guiding a workpiece, which preferably consists at least partly of wood, wood materials, metal materials or plastic, into and/or out of a processing machine, the processing machine having a conveying means for conveying the workpiece in a feed direction, has a support surface with air outlets, the air outlets being adapted to create an air cushion between the support surface and the workpiece using exiting air. According to the invention, the support surface can be arranged at a machine infeed and/or a machine outfeed of the processing machine, and has an extension portion which can be arranged adjacent to a conveying means end portion of the conveying means along the feed direction.

An advantage of the guide device according to the invention is that the workpiece can be guided on the support surface until it is taken over by the conveying means of the processing machine, since the extension portion of the support surface can be arranged adjacent to a conveying means end portion of the conveying means along the feed direction. This allows the workpiece to be transferred directly from the support surface, i.e. from the air cushion of the same, to the conveying means of the processing machine without the need for any additional element, such as infeed rollers or similar, to support the workpiece and possibly causing damage to the workpiece. In contrast to machine infeeds used in the past, the workpiece can therefore also be moved and turned in a transverse direction, which is a direction transverse to the feed direction, without being damaged. These properties also allow workpieces to be fed both manually by an operator and by automated feeding systems, or fully automatically by robots.

The guide device can be suitable or adapted to guide a workpiece, which preferably consists at least partly of wood, wood materials, metal materials or plastic, into and/or out of a processing machine, the processing machine having a conveying means for conveying the workpiece in a feed direction. The processing machine can be a woodworking machine, a metalworking machine or a plastics processing machine. The conveying means can be any conveying device that is suitable for conveying the workpiece. In particular, the conveying means can be a traction means, such as an endless circulating element. The endless circulating element can be a chain or belt on which a workpiece is conveyed for processing in the processing machine.

The feed direction is the direction in which the workpiece moves when it is conveyed by the conveying means. In the case where an endless circulating element such as a chain or belt is provided as the conveying means, the feed direction is the direction that extends along the longitudinal axis of the endless circulating element.

Depending on the intended use, the support surface can have a curved, planar or flat surface. The support surface can be made of metal or plastic, for example.

The air outlets can be holes that are evenly or unevenly distributed over the entire area or part of the area of the support surface. The holes can be circular and have a diameter of approx. 1 mm. The diameter can also be larger or smaller than 1 mm, as long as an air cushion can be created between the support surface and the workpiece by means of air exiting through the air outlets. For example, the diameter of the holes can be in a range of 0.1-2.0 mm, preferably 0.5-1.5 mm and more preferably 0.8-1.2 mm. In particular, the holes can be configured such that they have a constant cross-section along a direction perpendicular to the support surface. Such holes with an unvarying cross-section can be made very easily and without additional tools.

It is also conceivable to realize the air outlets by means of a support surface consisting of an air-permeable material through which air can flow or from which air can escape. For example, the support surface can be formed from a panel made of a porous material through which air can flow or from which air can escape.

To create the air cushion between the support surface and the workpiece, it is necessary for air to flow through the air outlets at a certain minimum pressure to bring the workpiece into a floating state. The principle behind the creation of such an air cushion is known from the prior art, for example from common air cushion tables.

The machine infeed or machine outfeed can be understood here as a part or section of the processing machine at which the workpiece is fed into the processing machine or is guided out of the processing machine. In particular, the conveying means of the processing machine can be provided at the machine infeed so that the workpiece can be received by the conveying means at the machine infeed and conveyed or transported by the conveying means for further processing in the processing machine.

The fact that the support surface of the guide device can be arranged at the machine infeed and/or the machine outfeed of the processing machine ensures that the workpiece can be guided or moved or transported on the guide device, in particular by an operator, by an automated feed system or by a robot, and can be transferred from the guide device to the processing machine. The same applies by analogy to the machine outfeed of the processing machine. For the support surface to be suitable to be arranged or arrangeable at the machine infeed and/or the machine outfeed of the processing machine, it may be necessary, in particular, for the support surface and the machine infeed or machine outfeed to be at approximately the same height.

The extension portion provided according to the invention is a portion of the support surface which, when the support surface of the guide device is arranged at the machine infeed and/or the machine outfeed of the processing machine, is arranged adjacent to the conveying means end portion of the conveying means when viewed along the feed direction. In other words, the extension portion extends adjacent to the conveying means end portion, at least partially, in a direction that is parallel to the feed direction. In the example where an endless circulating element (such as a belt) serves as a conveying means, the feed direction corresponds to the longitudinal axis of the endless circulating element. Viewing a conveying surface of the endless circulating element from above, the endless circulating element has a long side and a short side, the longitudinal axis being the axis of the long side. In this example, the extension portion of the support surface can be arranged adjacent to the long side of the endless circulating element, or, more precisely, adjacent to an end portion thereof.

In one example, the support surface can have a substantially rectangular shape. In this case, the extension portion can be configured so that the rectangular shape of the support surface has a notch at one corner. Consequently, the support surface has a recessed portion with an internal angle. In particular, the support surface can have an L-shaped end portion. In this case, one side of the L-shaped end portion can be arranged adjacent to the conveying means end portion when viewed in the feed direction, and the other side of the L-shaped end portion can be arranged in front of the conveying means end portion when viewed in the feed direction.

The end portion or conveying means end portion is a portion of the conveying means in which the workpiece is located first at the machine infeed when processing the workpiece in the feed direction, or in which the workpiece is located last at the machine outfeed when processing the workpiece in the feed direction. In particular, the conveying means end portion can be understood as an extended area that not only includes one end of the conveying means, but also includes a certain extension along the feed direction starting from one end of the conveying means.

A conventional air cushion table or a conventional guide device is provided in front of the machine infeed when viewed in the feed direction of the processing machine as a free-standing air cushion table, in particular standing on its own table legs. Such air cushion tables on which a workpiece can be guided into a processing machine, for example, always include additional elements, such as infeed rollers, in front of or adjacent to the conveying means of the processing machine in order to support the workpiece while it is being conveyed into the machine. These are necessary because conventional air cushion tables end before the conveying means end portion when viewed in the feed direction. Since the guide device according to the invention has an extension portion on the support surface which can be arranged along the feed direction adjacent to a conveying means end portion of the conveying means, the workpiece can be further guided on the air cushion until it is fully taken over by the transport means. It is therefore not necessary to provide additional elements in front of or adjacent to the conveying means to support the workpiece, thus preventing the workpiece from being damaged by possible transverse displacements due to the additional elements.

In preferred embodiments, the extension portion can be arranged on both sides adjacent to the conveying means end portion along the feed direction.

Depending on the application, the extension portion can be symmetrical or asymmetrical relative to the feed direction. In the example where an endless circulating element (such as a belt) serves as a conveying means, in which the long side corresponds to the feed direction, the extension portion of the support surface can be arranged on both long sides of the endless circulating element, more precisely adjacent to the end portion thereof. In this case, the extension portion can be symmetrical or asymmetrical relative to the longitudinal axis of the endless circulating element (axisymmetrical). In contrast to conventional guide devices, such as air cushion tables, with this configuration it is possible to guide the workpiece stably on the air cushion until it is fully taken over by the transport means. As the extension portion can be arranged on both sides adjacent to the conveying means end portion, the workpiece can be transferred to the conveying means of the processing machine particularly safely.

In preferred embodiments, a recess is provided at a support surface end portion of the support surface, the recess being adapted to embrace the conveying means end portion to form the extension portion.

The support surface can have a square or rectangular shape, for example. In this case, any of the four sides of the square or rectangular shape can be regarded as the support surface end portion.

A recess can be understood as a cut-out in the support surface at an end portion thereof. The recess can extend from the support surface end portion towards a central portion of the support surface. The recess is dimensioned such that a conveying means end portion can be accommodated therein and the portions of the support surface forming the recess can embrace the conveying means end portion on both sides to form the extension portion.

With this configuration, the extension portion of the support surface can be realized in a simple way. In particular, the support surface can be formed in one piece with this configuration.

In preferred embodiments, a length of the recess from the support surface end portion to a recess base of the recess is at least 10 cm, preferably at least 20 cm and more preferably at least 30 cm.

The recess base of the recess can be understood as the part of the recess that is furthest away from the support surface end portion where the recess is provided.

The longer the recess, the further the conveying means end portion can be accommodated in the recess. If the workpieces to be guided on the guide device are large, for example, the recess can be made longer to allow the workpieces to be transferred fully from the guide device to the conveying means. Consequently, this configuration ensures a safe and stable transfer of the workpiece from the guide device to the conveying means depending on the size of the workpiece.

In preferred embodiments, the recess is substantially U-shaped, V-shaped or horseshoe-shaped.

The term “substantially” is to be understood as also including shapes that are not exactly U-shaped, V-shaped or horseshoe-shaped. In particular, this can also include shapes that are asymmetrical relative to the feed direction, as in a case where the extension portion is longer on one side of the conveying means than on the other side. U-shaped can, in particular, also include a recess whose shape has right angles.

By providing these different shapes, it is possible to provide a guide device that is best adapted to the respective needs and conditions of the processing machine and still obtain the above-mentioned technical effects in connection with the extension portion of the guide device.

In preferred embodiments, the support surface is formed in one piece.

With this configuration, it is possible to provide a compact guide device which is also highly stable due to its one-piece design.

In preferred embodiments, the support surface can be arranged on the conveying means in such a way that the support surface directly adjoins the conveying means.

In particular, this can be understood to mean that no further components or elements are arranged between the support surface and/or the extension portion of the support surface on the one hand and the conveying means on the other. This also helps to ensure that the workpieces can be moved in a transverse direction at right angles to the feed direction without the surface of the workpieces being damaged by additional elements or components. This can also increase safety, as no foreign bodies can enter the space between the support surface and the conveying means.

In preferred embodiments, the air outlets have a constant cross-section along a direction perpendicular to the support surface.

It is also conceivable that the air outlets of the present invention have the shapes and configurations described in the prior art. However, if the air outlets have the preferred constant cross-sections, it is possible to manufacture the air outlets easily and without additional tools, components or assembly effort, as the holes do not require nozzles or bevels.

In preferred embodiments, the cross-section of the air outlets is circular and has a diameter of 0.1-2.0 mm, preferably 0.5-1.5 mm and more preferably 0.8-1.2 mm.

With such a configuration of the diameter of the air outlets, despite an open cross-section it is possible to keep the air consumption of the guide device low, i.e. not significantly higher than comparable air cushion tables of other designs.

In preferred embodiments, the air outlets are distributed over the entire area of the support surface.

The air outlets can be arranged unevenly or evenly over the entire area of the support surface. For example, the air outlets can have a lower density in one area of the support surface than in another area of the support surface.

With this configuration, it is possible to keep the workpiece in a floating state over the entire area of the support surface thanks to the air cushion created.

In preferred embodiments, the guide device is an air cushion table attachable to the processing machine.

The air cushion table can have or consist of a base body and a cover panel. The base body can have small ducts on the surface to distribute the air over the entire surface of the air cushion table. The cover panel can be provided with holes distributed over the entire surface of the air cushion table. The holes can be arranged so that they lie directly above an air duct of the base body. The air can be supplied selectively or collectively via an air supply network of the processing machine or generated via a separate fan.

The air cushion table can, for example, be removably attachable to the processing machine. This can be realized by means of bolted connections, for example. In particular, the air cushion table can be configured so as to be attachable to the processing machine without additional base elements. With such a configuration, the air cushion table can be kept compact compared to free-standing air cushion tables on comparable processing machines.

According to a further aspect of the invention, a processing machine is provided for processing a workpiece, which preferably consists at least partly of wood, wood materials, metal materials or plastic, the processing machine having a conveying means for conveying the workpiece in a feed direction, and a guide device for guiding the workpiece into and/or out of the processing machine according to one of the preceding embodiments.

In particular, the processing machine can be a woodworking machine.

The technical advantages of the processing machine according to this configuration are the same as the technical advantages described above in connection with the guide device according to the invention.

In preferred embodiments of the processing machine, the conveying means comprises a traction means, in particular an endless circulating element, such as a chain or a belt.

The same explanations and considerations as described above in connection with the guide device according to the invention are applicable to the case in which an endless circulating element is used as the conveying means.

In preferred embodiments of the processing machine, the processing machine further comprises an air supply network, the air supply network being adapted to supply the guide device with air.

An air supply network can be provided on the processing machine, for example, to supply air to parts of the processing machine, such as tool parts. Furthermore, the air supply network can be provided to clean a machine area of by-products of workpiece processing, such as chips, using an air gun. According to the invention, such an air supply network can also be adapted to provide the guide device with air. For this purpose, corresponding air connections can be provided on the guide device, for example on the underside of a base plate, which has air ducts for creating the air cushion table. Such configurations make it possible to reduce the number of components, as a separate fan is not required to create the air cushion via the guide device. Nevertheless, it is conceivable that, in one example, the processing machine provides a separate fan for this purpose.

### BRIEF DESCRIPTION OF FIGURES

Further preferred features and advantages of the invention are given in the following description of the figures.

FIG. 1 shows a schematic perspective view of a preferred processing machine with a preferred guide device.

FIG. 2A shows a schematic side view of a preferred guide device.

FIG. 2B shows a schematic plan view of the guide device from FIG. 2A.

FIG. 3 shows a schematic perspective view of the upper side of the guide device from FIG. 2.

FIG. 4 shows a schematic perspective view of the underside of the guide device from FIG. 3.

### DETAILED DESCRIPTION OF PREFERRED EMBODIMENTS

Preferred embodiments of the invention are explained in detail below, with reference to the attached figures, in order to describe the invention by means of illustrative examples. Further modifications of certain individual features described in this context can be combined with other features of the described embodiments so as to form further embodiments of the invention.

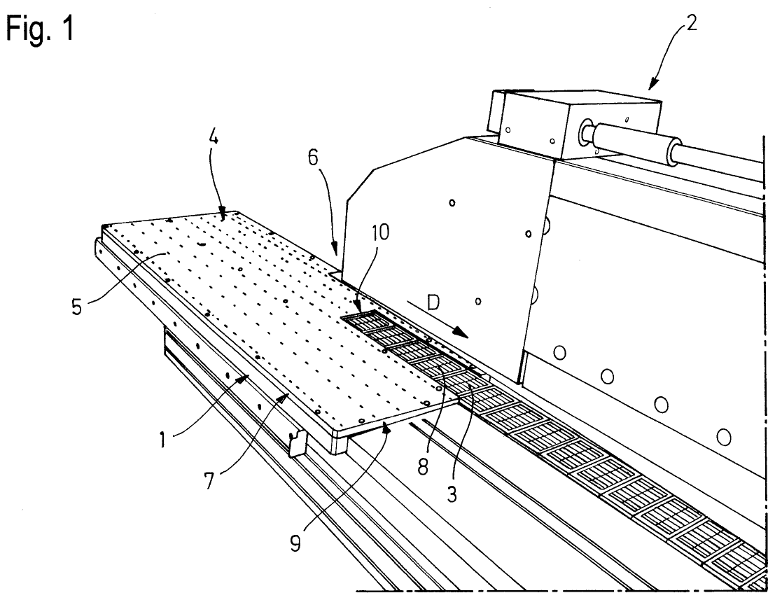

FIG. 1 shows a schematic perspective view of a preferred processing machine 2 with a preferred guide device 1.

The processing machine 2 has a machine infeed 6, in which a workpiece is guided into the processing machine 2. The processing machine 2 also has a conveying means 3, which, in the embodiment shown in FIG. 1, is an endless circulating element in the form of a chain. In the embodiment shown, the chain moves along a feed direction D. A workpiece placed on the chain is therefore also moved along the feed direction D to be processed in the processing machine. The chain or the conveying means 3 has a conveying means end portion 8 at the machine infeed 6, which corresponds to the start of the conveying means 3 in the feed direction D. In the machine infeed 6, a workpiece to be processed is fed to the conveying means end portion 8 of the conveying means 3 in order to be conveyed on the conveying means 3 or the chain through the processing machine.

The preferred guide device 1 shown in FIG. 1 has a substantially rectangular shape. In this example, the guide device 1 is arranged on or attached to the processing machine 2, more precisely on/to its machine infeed 6. The support surface 4 of the guide device 1 has a flat shape.

As shown in FIG. 1, the support surface 4 has a recess 10 at a support surface end portion 9 thereof, which extends from the support surface end portion 9 towards the rear side of the support surface 4. It can be also seen from FIG. 1 that the recess 10 is adapted or configured so as to accommodate the conveying means end portion 8 of the conveying means 3. Consequently, the extension portion 7 of the support surface 4 is arranged on both sides adjacent to the conveying means end portion 8 of the conveying means 3 when viewed along the feed direction D.

The guide device 1 in FIG. 1 has air outlets 5 on its support surface 4 to create an air cushion. In this embodiment, the guide device 1 is an air cushion table. Starting from a rear side of the support surface 4, which is a side that is furthest away from the processing machine 2 when viewed along the feed direction D, a workpiece is placed on the support surface 4. The air exiting through the air outlets 5 creates an air cushion between the support surface 4 and the workpiece, so that the workpiece is placed in a floating state above the support surface 4, in which state the workpiece can be moved with little effort, for example by an operator. To process the workpiece, the workpiece must be fed into the machine infeed 6 of the processing machine 2. For this purpose the workpiece is moved, starting from the rear side of the support surface 4, over the support surface 4 substantially in the feed direction D until it is taken over by the conveying means 3, or more precisely by its conveying means end portion 8, to be conveyed through the processing machine 2. The workpiece is transferred from the guide device 1 to the processing machine 2 at the extension portion 7 of the support surface 4. By providing the extension portion 7 on the support surface 4, it is possible to keep the workpiece in a floating state above the support surface 4 until it is fully transferred to the conveying means 3. As a result, it is not necessary to provide additional elements, such as infeed rollers and the like, to support the workpiece when it is transferred to the processing machine, as is the case with conventional air cushion table arrangements at the machine infeed of a processing machine, for example.

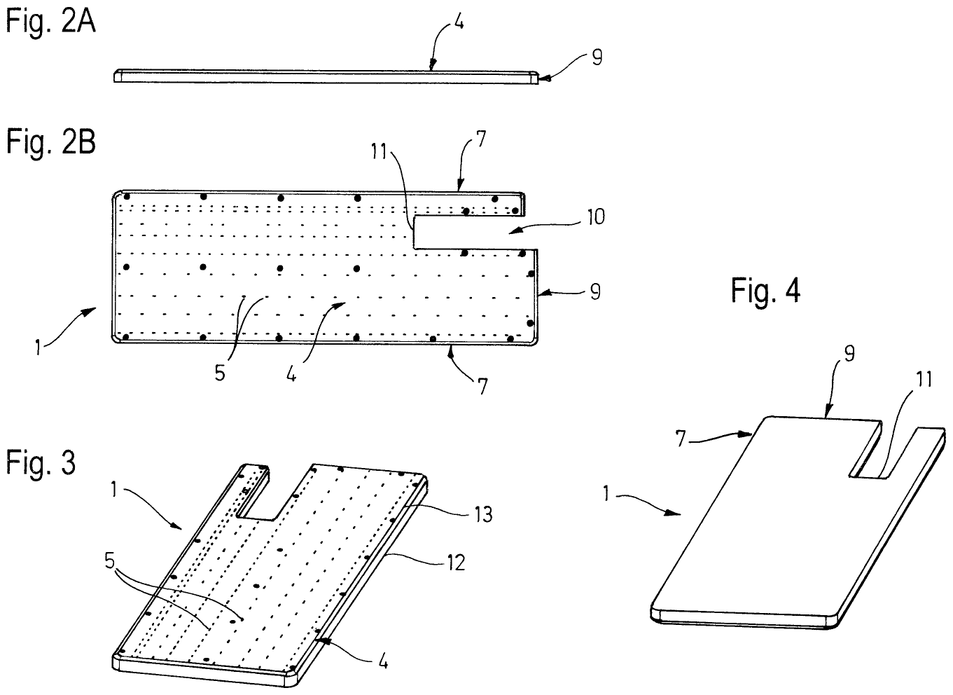

FIG. 2A shows a schematic side view of a preferred guide device 1. As shown in FIG. 2A, the guide device 1 has a substantially flat support surface 4. The guide device 1 can be supplied with air via air connections on its underside. The air can be supplied by the air supply network of the processing machine 2. In this embodiment, the guide device 1 has a length of approximately 0.8-2.0 m, preferably 0.8 to 1.2 m, along its longitudinal axis.

FIG. 2B shows a schematic plan view of the guide device 1 from FIG. 2A. The air outlets 5 are distributed over the entire area of the support surface 4. In this embodiment, however, the density of the air outlets 5 per unit area is greater on one side of the support surface 4 than on the other side of the support surface 4. This can have advantages when guiding workpieces, depending on the type of workpiece and/or type of processing machine.

On the right-hand side of the guide device 1 in FIG. 2B, the support surface 4 has an extension portion 7, which in this embodiment is formed by the provision of the recess 10. As can be seen in FIG. 2B, the recess 10 extends from the support surface end portion 9 to the recess base 11 of the recess 10. The recess 10 is adapted to accommodate the conveying means end portion 8, for example of the conveying means 3 in FIG. 1. In this embodiment, the support surface 4 accordingly has an extension portion 7, which can be arranged on both sides adjacent to the conveying means end portion 8. This allows particularly safe and stable transfer of the workpieces to the conveying means end portion 8 of the conveying means 3. Depending on the conditions and requirements of the processing machine 2 and/or of the workpieces, the extension portion 7 can be shorter on one side of the conveying means end portion 8 than on the other side of the conveying means end portion 8, as shown in FIG. 2B. The extension portion 7 can also be narrower on one side of the conveying means end portion 8 than on the other side of the conveying means end portion 8.

FIG. 3 shows a schematic perspective view of the upper side of the guide device 1 from FIG. 2. This view shows the structure of the guide device 1. In this embodiment, the guide device 1 is an air cushion table. The air cushion table has a base body 13 and a cover panel 14, which corresponds to the support surface 4 with air outlets 5. The base body 13 has small ducts (not shown) on its surface to distribute the air over the entire surface of the air cushion table. The cover panel 14, which is provided with holes distributed over the entire surface of the air cushion table as air outlets 5, is arranged above the base body 13 so that the holes lie directly above an air duct of the base body 13.

FIG. 4 shows a schematic perspective view of the underside of the guide device 1 from FIG. 3. The guide device 1 can have a plurality of air connections on its underside, for example for connection to the air supply network of the processing machine 2.

### LIST OF REFERENCE NUMBERS

1 Guide device
2 Processing machine
3 Conveying means
4 Support surface
5 Air outlet/air outlets
6 Machine infeed
7 Extension portion
8 Conveying means end portion
9 Support surface end portion
10 Recess
11 Recess base
12 Base body
13 Cover panel

1. Guide device for guiding a workpiece into or out of a processing machine, the processing machine having a conveying means for conveying the workpiece in a feed direction (D), wherein the guide device has:
a support surface with air outlets,
wherein the air outlets are adapted to create an air cushion between the support surface and the workpiece using exiting air,
wherein the support surface can be arranged at a machine infeed or a machine outfeed of the processing machine, and has an extension portion which can be arranged adjacent to a conveying means end portion of the conveying means along the feed direction (D).

2. Guide device according to claim 1, wherein the extension portion can be arranged on both sides adjacent to the conveying means end portion along the feed direction (D).

3. Guide device according to claim 1, wherein a recess is provided at a support surface end portion of the support surface, the recess being adapted to accommodate the conveying means end portion in order to form the extension portion.

4. Guide device according to claim 3, wherein a length of the recess from the support surface end portion to a recess base of the recess is at least 10 cm.

5. Guide device according to claim 3, wherein the recess is substantially U-shaped, V-shaped or horseshoe-shaped.

6. Guide device according to claim 1, wherein the support surface is formed in one piece.

7. Guide device according to claim 1, wherein the support surface can be arranged on the conveying means in such a way that the support surface directly adjoins the conveying means.

8. Guide device according to claim 1, wherein the air outlets have a constant cross-section along a direction perpendicular to the support surface.

9. Guide device according to claim 8, wherein the cross-section of the air outlets is circular and has a diameter of 0.1-2.0 mm.

10. Guide device according to claim 1, wherein the air outlets are distributed over the entire area of the support surface.

11. Guide device according to claim 1, wherein the guide device is an air cushion table attachable to the processing machine.

12. Processing machine for processing a workpiece, which preferably consists at least partly of wood, wood materials, metal materials or plastic, the processing machine having:
a conveying means for conveying the workpiece in a feed direction (D), and
a guide device for guiding the workpiece into or out of the processing machine according to claim 1.

13. Processing machine according to claim 12, wherein the conveying means comprises a traction means, in particular an endless circulating element such as a chain or a belt.

14. Processing machine according to claim 12, wherein the processing machine further comprises an air supply network, the air supply network being adapted to supply the guide device with air.

15. Processing machine according to claim 12, wherein the processing machine further comprises a fan, in particular an electric fan, the fan being adapted to supply the guide device with air.
